(19) United States
(12) Patent Application Publication
(10) Pub. No.: US 2006/0102065 A1
(43) Pub. Date: May 18, 2006

(54) Lifting and extension devices

(76) Inventor: Peter Mele, Crown Point, NY (US)

Correspondence Address: Peter Mele, White Church Road, P.O. Box 533, Crown Point, NY, 12928, US

(21) Appl. No.: 10/989,856

(22) Filed: Nov. 15, 2004

(51) Int. Cl. B66D 1/36

(52) U.S. Cl. 114/369

(57) ABSTRACT

Method and apparatus for the lifting and extension of objects, including the lifting and elevating objects such as boats, and the extension and support of protective covers such as awnings and the like.

### BACKGROUND OF THE INVENTION

This invention relates to lifting and extension devices and, more particularly, to a lifting device for elevating objects such as boats, and an extension device for use to support protective covers such as awnings and the like.

It often is necessary to elevate objects in order to move them from a lower position to an upper position. Such is the case with auxiliary vessels such as lifeboats and dinghies that are used with yachts and similar vessels. The conventional practice is to employ a davit formed by inverted L-shaped, heavy structural supports that are positioned in the vicinity of shipboard railings for vertical loads. Each support includes an end-position pulley that is operated using lines that extend from within the vessel through the pulley and is attached to the boat. It is then necessary, in order to elevate the boat, to pull on both lines of both supports. This requires coordination of the pulling effort in order to prevent the boat from tilting as it is elevated from the water or lowered into the water, and requires heavy structure and connection to the hull to support the vertical load.

Accordingly, it is an object of the invention to overcome the difficulties, complexity and objections associated with the conventional davit for storage of auxiliary vessels, such as lifeboats.

Another object of the invention is to provide for the elevation of auxiliary vessels such as lifeboats by apparatus that can have other uses as well.

A related object is to provide an elevational mechanism for lifeboats, but can also serve as an extension frame for such devices as awnings and the like.

### SUMMARY OF THE INVENTION

In accomplishing the foregoing and related objectives, the invention employs structures already on the boat, or building, which are higher than the conventional davit, e.g. such as masts or building walls, to support the vertical load of the dinghy, or other device, and allow for a much less heavy and costly structure, which is far more easily attached to handle horizontal loads.

In particular, the invention provides apparatus for moving an object with a davit or awning frame formed by opposed side members joined to an end member. A first line has one end connected to the intersection of the frame with one of the side members, and a second line has one end connected at the intersection of the frame with the other side members. The other ends of the first line and the second line are connected to an end extending to and beyond a pulley, so that a force applied to the end extending to and beyond a pulley can exert a lifting force at the connections of the first line and the second line to the end member.

In accordance with one aspect of the invention, the apparatus is for elevating an object in the form of a boat attachable to the frame. Alternatively, the apparatus is for providing a frame to support a protective cover, such as an awning.

In accordance with another aspect of the invention, the boat is attachable to the end member of the frame, or to the side members of the frame. The first line can extend continuously to the second line, and a connection is attached to a mid-position of the continuous extension of the first line to the second line. The connection to the continuous extension causes the first line and the second line to form a triangular configuration with respect to the end member. The continuous extension can be cord-like.

In a method of the invention for moving an object, the steps include: (a) forming a frame by opposed side members joined to an end member; (b) connecting one end of a first line to the intersection of the frame with one of the side members; (c) connecting one end of a second line to the intersection of the frame with the other of the side members; (d) connecting the other ends of the first line and the second line by an end extending to and beyond a pulley; whereby a force applied to the extension of the end can exert a lifting force at the connections of the first line and the second line to the end member.

The method includes the step of elevating the object as a boat attachable to the frame, and the step of providing a protective cover using the frame to support an awning. The method includes the step of attaching the boat to the frame.

In the method of the invention for moving an object from one position to another position, the steps include of: (a) attaching a frame to the object; (b) connecting a line to the frame; and (c) passing the line over a pulley connected to a position in fixed relationship to the object, higher than the davit or awning frams.

The method for elevating a boat from a water level to an elevated position includes the steps of: (a) attaching a frame to the boat; (b) connecting a line to the frame; and (c) passing the line over a pulley connected to a position in fixed relationship to the boat, and higher than the davit frame.

The method also includes supporting an awning from an elevated position by the steps of (a) attaching a frame to the awning; (b) connecting a line to the frame; and (c) passing the line over a pulley connected to a position in fixed relationship to the awning.

The method further includes the step of pulling the line over the pulley to elevate the boat in accordance with the extent to which the line is pulled over the pulley.

The method also includes the step of releasing the line over the pulley to lower the awning in accordance with the extent to which the line is released over the pulley.

The method further includes the step of pulling the line over the pulley to cause the connection to the continuous extension to form a triangular configuration with respect to the end member.

The method additionally includes the step of forming a triangular configuration of the continuous extension with respect to the end member when the awning is elevated or lowered.

### DESCRIPTION OF THE DRAWINGS

Other and more detailed objects and advantages of this invention will appear from the following description and the accompanying drawings.

In the drawings:

FIG. 1 is a perspective view of a conventional davit in accordance with the prior art for lowering and raising an auxiliary boat with respect to the water surface supporting the principal vessel on which the davit is located.

FIG. 2 is a perspective view of the preferred davit frame in accordance with the invention for providing additional lift in elevating and lowering an auxiliary boat with respect to a principal vessel, or for providing additional lift in raising and lowering an awning.

FIG. 2A is a perspective view of an alternative davit frame in accordance with the invention for elevating and lowering an auxiliary boat with respect to a principal vessel, or for raising and lowering an awning.

FIG. 2B is a partial side view of the davit of FIG. 2A.

FIG. 2C is a top view of the davit of FIG. 2A.

FIG. 2D is a front view of the davit of FIG. 2A.

FIG. 3A is a perspective view of a vessel equipped with an alternative davit in accordance with the invention.

FIG. 3B is a perspective view showing the davit of FIG. 3A being used to elevate an auxiliary boat.

FIG. 3C is an end view of the elevated auxiliary boat of FIG. 3B.

FIG. 4A is a perspective view of a lowered awning using the frame of the invention.

FIG. 4B is a perspective view of an alternative lowered awning using the frame of the invention

### DETAILED DESCRIPTION

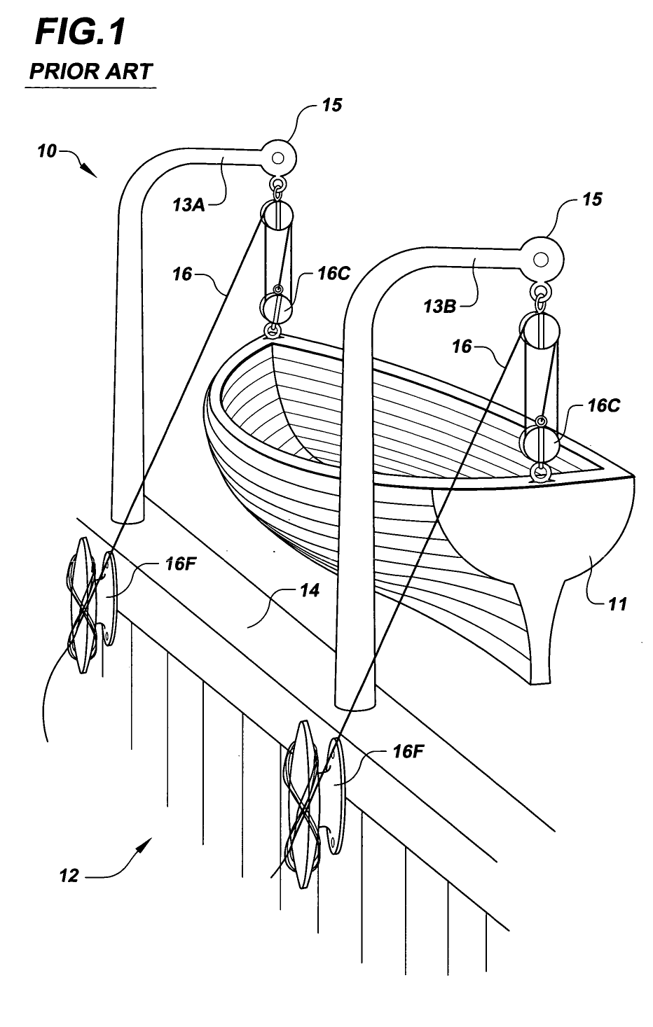

With reference to the drawings, FIG. 1 is a perspective view of a davit 10 in accordance with the prior art for lowering and raising an auxiliary boat 11 with respect to a water surface (not shown) on which a principal vessel 12 is floating. The davit 10 is formed by L-shaped supports 13A and 13B, which extend from the railing 14 of the vessel 12. At the end of each support 13A and 13B, is a pulley 15 through which a line 16 extends from a fitting 16F on the railing 14 through the pulley 15 to a connection 16C on the boat 11.

When the boat 11 is to be lowered from its elevated position to the surface of the water on which the vessel 12 is floating, the lines 16 are loosened to allow the boat 11 to be lowered. It is apparent that unless both lines 16 are lowered simultaneously and evenly, the boat 11 will not be lowered properly and may even be engulfed by the water surface so as to render the boat not usable. In addition, it is necessary for two persons to engage in the lowering operation again adding to the possibility that the boat 11 will not be lowered evenly. Supports 13A and 13B must be very strong and have reinforced attachment to the vessel 12.

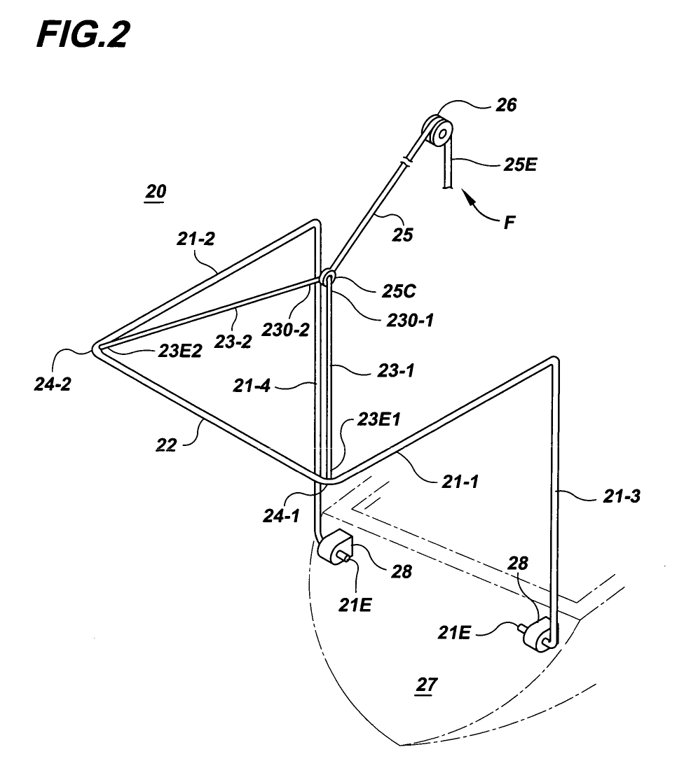

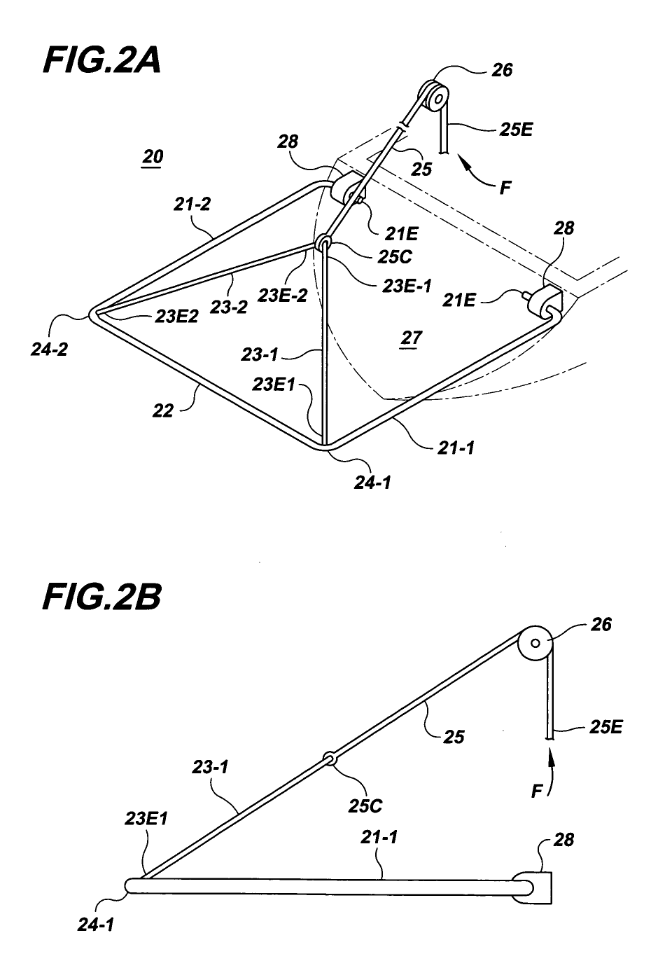

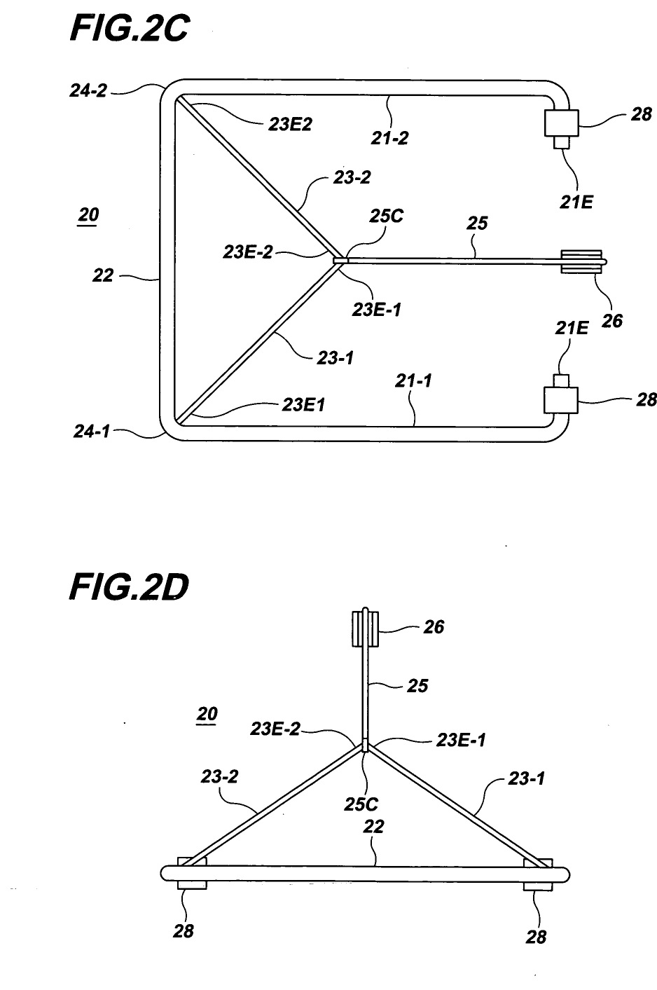

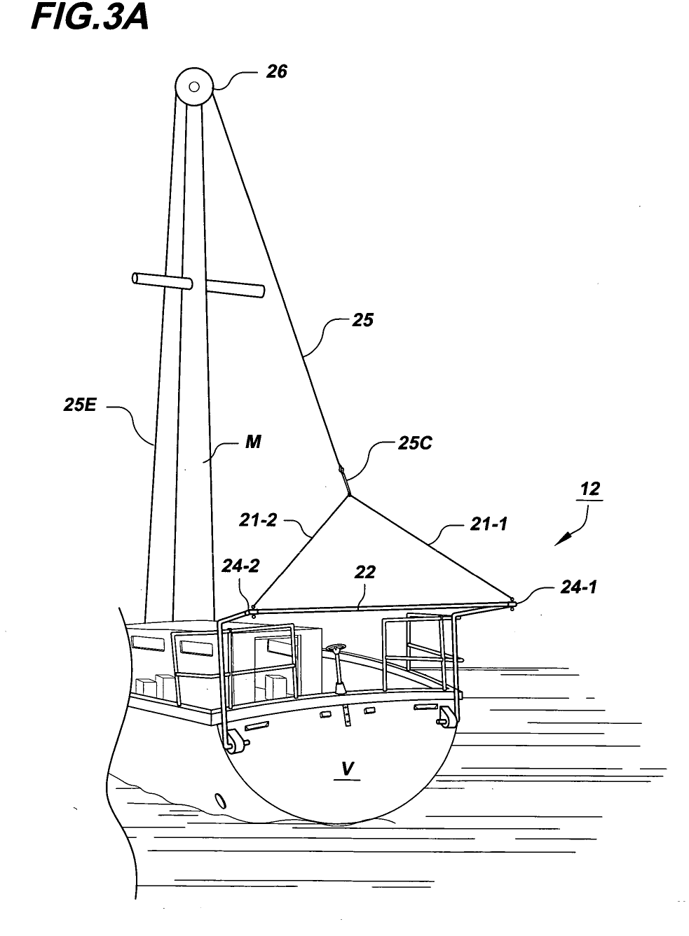

The invention overcomes the difficulties associated with the davit 10 of FIG. 1 by the apparatus of FIGS. 2 and 2A through 2D for moving an object, such as a boat, or an awning by a frame 20 or 20′ formed by opposed side members 21-1 and 21-2 joined to an end member 22. A first line 23-1 has one end 23-E1 connected at the intersection 24-1 of the end member 22 with the side member 21-1. A second line 23-2 has one end 23-E2 connected at the intersection 24-2 of the end member 22 with the side members 21-2. The other ends 23-O1 and 23-02 of the first line 23-1 and the second line 23-2 are connected to a further line 25 having an end 25-E extending to and beyond a pulley 26.

Although the connection to the further line 25 is at the mid-position of a continuous extension of the first line 23-1 to the second line 23-2, the lines 23-1 and 23-2 need not extend continuously and their connection to the further line 25 need not be at a mid-position.

For the mid-position connection of FIG. 2A, the continuous extension causes the first line 23-1 and the second line 23-2 to form a triangular configuration with respect to the end member 22. The continuous extension can be cord-like, or take any other form that is suitable for receiving a force F applied at the end of the line 25.

As a result, a force applied to the end 25-E of the line 25 can exert a lifting force F at the connection of the first line 23-1 and the second line 23-2 to the end member 22.

When an object is to be elevated by a boat 27, shown in phantom in FIG. 2, the object to be elevated (not shown in FIG. 2) can be attachable to the frame 20 in a variety of ways.

In FIG. 2 the side members 21-1 and 21-2 extend at an approximate right angle to respective side members 21-3 and 21-4 where there ends 21E are inserted into connectors 28 that are attachable to the boat 27.

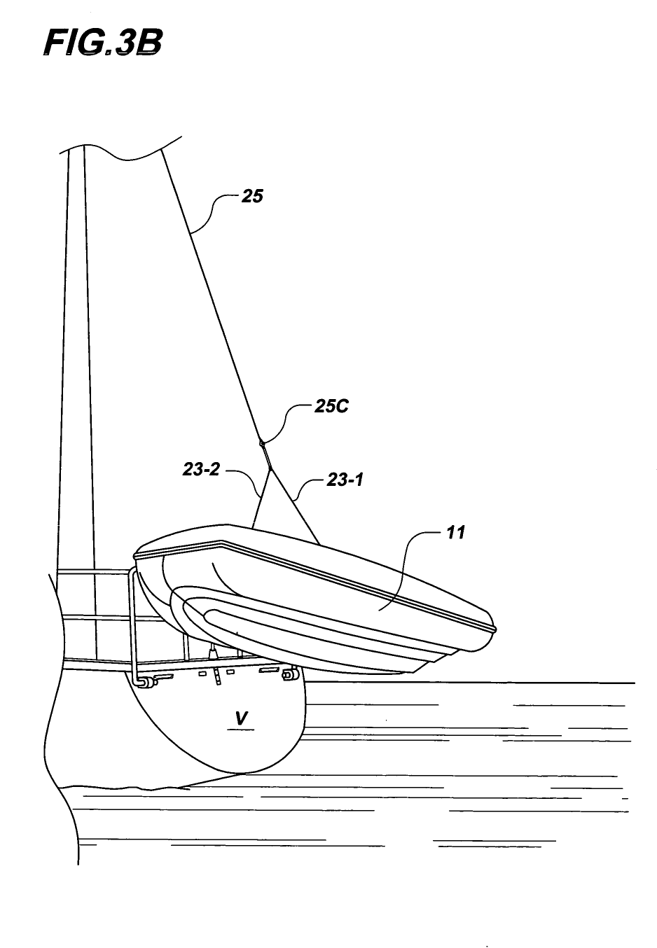

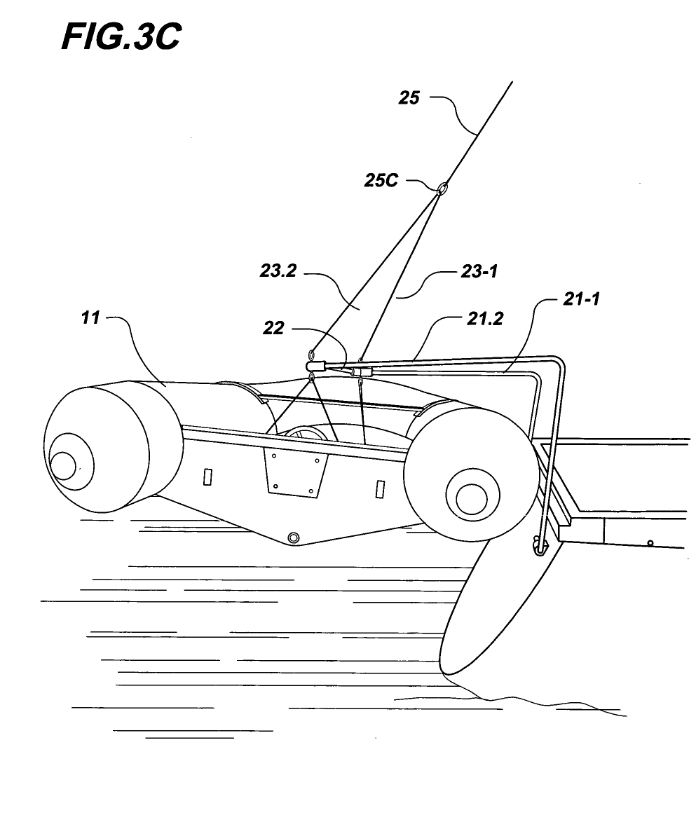

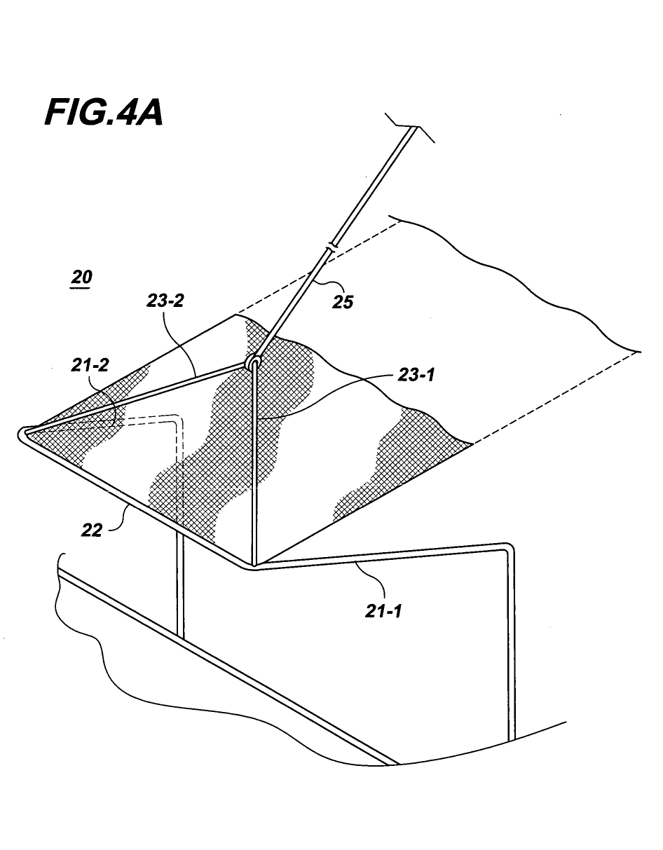

As shown in FIG. 2A, the opposed side members 21-1 and 21-2 extend directly to connectors 28 that receive rotationally the ends 21-E. Consequently, when the force F is applied to the line 25, the frame 20′ rotates in the connectors 28 until it is in a higher position in relation to its original horizontal position with reference to the vessel 27. Thereafter, as shown in FIG. 3B, further force F causes elevation of the boat 11, that is being raised after being suitably attached to the dinghy frame 20, to position it, for example, alongside the vessel to which the pulley 26 (not shown in FIG. 3B) is connected above the line 25.

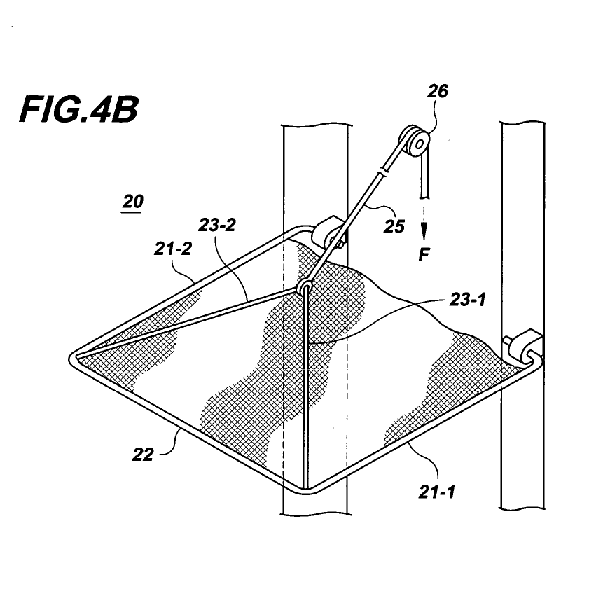

Alternatively, the frames 20 and 20′ can provide a frame for a protective cover, wherein the frames 20 and 20′ supports awnings 40 and 40′, as shown in FIGS. 4A and 4B.

In addition to attachment of the davit frame 20 to a boat 11, as shown in FIG. 3B, the davit frame 20′ of FIG. 2A, can be used to attach the boat 11 (not shown in FIG. 2A).

In FIG. 2B, which is a partial side view of the davit 20 of FIG. 2A, the slide member 21-1 is horizontal and the lines 23-1 and 25 extend linearly to the pulley 26 by being held in position either because of a force F applied at the end 25E or because the line 25E is fixed to a connector on the vessel (not shown) to which the pulley 26 is attached. When the force F is released, the pull of gravity will cause the frame 20 to rotate downwardly with respect to the connectors 28 so that both the frame 20 and the lines 23 and 25 will adopt a more vertical position.

In FIG. 2C, which is a top view of the davit 20 of FIG. 2A, the lines 23-1 and 23-2 form the sides of an isosceles triangle whose base is the end member 22.

In FIG. 2D, which is a front view of the davit of FIG. 2A, the line 25 elevates the sides 23-1 and 23-2 of the isosceles triangle formed relative to the base 22.

FIG. 3A shows a vessel V equipped with the davit frame 20 in accordance with the invention. As with the davit 20′ of FIG. 2A, the alternative davit 20 has side tubes 21-1 and 21-2, but has added vertical tubes 21-3 and 21-4 positioned between hinges 38 on the mother ship V and the side members 21-1 and 21-2 of the davit frame 20 to provide additional vertical lift, and further overcome the difficulties associated with the davit 10 of Figure

Consequently the davit frame 20 is formed by opposed side members 21-1 and 2-2 joined to an end member 22. A first line 23-1 has one end 23-E1 connected at the intersection 24-1 of the end member 22 with the side member 21-1. A second line 23-2 has one end 23-E2 connected at the intersection 24-2 of the end member 22 with the side member 21-2. The other ends 23-O1 and 23-02 of the first line 23-1 and the second line 23-2 are connected to a further line 25 having an end 25-E extending to and beyond a pulley 26 mounted on a mast M of the vessel V.

Although the connection to the further line 25 is at the mid-position of a continuous extension of the first line 23-1 to the second line 23-2, the lines 23-1 and 23-2 need not extend continuously and their connection to the further line 25 need not be at a mid-position.

For the mid-position connection of FIG. 3A, the continuous extension causes the first line 23-1 and the second line 23-2 to form a triangular configuration with respect to the end member 22. The continuous extension can be cord-like, or take any other form that is suitable for receiving a force F applied at the end of the line 25.

As a result, a force applied to the end 2-E of the line 25 can exert a lifting force F at the connection of the first line 23-1 and the second line 23-2 to the end member 22.

When the object to be elevated is a boat 11, shown in FIG. 3B, it is attachable to the davit of the frame 20 in a variety of ways. As indicated in FIG. 3A, connectors 28 are attachable to the vessel V to receive rotationally the ends 21-E of the opposed side members 21-1 and 21-2. Consequently, when the force F is applied to the line 25, the frame 20 rotates in the connectors 28 in relation to its original horizontal position.

By contrast with the davit of FIG. 2A, the davit D of FIG. 3A, is connectable to the boat 11 by ring attachments 29 at the intersections of the end member 22 with the side members 21-1 and 21-2. To make the connection, the force F holding the davit frame 20 in a horizontal position in FIG. 3A, is released to cause the davit frame 20 to swing downwardly toward the surface of the water where connection to the boat 11 is made in any standard fashion.

Thereafter, reapplication of the force F causes elevation of the boat 11 to the position shown in FIGS. 3B and 3C.

Alternatively, the frames 20 and 20′ can provide a protective cover, wherein the frame 20 or 20′ is covered by an awning 40 or 40′, as shown in FIGS. 4A and 4B.

In the method of the invention for moving an object, the steps include forming a frame 20 or 20′ by opposed side members 21-1 and 21-2 joined to an end member 22.

One end of a first line 23-1 or 33-1 is connected to the intersection of the frame 20 or 20′ with one of the side members 21-1. One end of a second line 23-2 is connected to the intersection of the frame 20 or 20′ with the other side member 21-2.

The other ends of the first line 23-1 and the second line 23-2 are connected to a further line 25 having an end extending to and beyond a pulley 26, whereby a force F applied to the end of the line 25 can exert a lifting force at the connections of the first line 23-1 and the second line 23-2 to the end member 22.

The method can provide for the step of elevating an object such as the boat 11 attachable to the davit frame 20 or 20′, or can provide a protective cover, such as a frame 40 or 40′ covered by an awning 41 or 41′. The method includes the step of attaching the boat 11 to the frame 20 or 20′ or attaching a cover to the frame 40 or 40′.

The method of moving an object from one position to another position, includes the steps of attaching a frame 20 or 20′ to an object, such as a boat 11, connecting a line to the frame 20 or 20′ and passing the line over a pulley 26 connected to a position in fixed relationship to the object.

In the method of elevating a boat 11 from a water level to an elevated position, the steps include attaching a frame 20 or 20′ to the boat 11, connecting a line to the frame 20 or 20′, and passing the line over a pulley 26 connected to a position in fixed relationship to the vessel V.

In the method of providing an awning extension 41 for the vessel V, as shown in FIG. 4A, the steps include connecting a line 25 to the frame 22 with the awning extension 41 attached to the end member 22, leaving an angle A, as shown in FIG. 4A, between the awning extension 41 and the plane formed by the side members 21-1 and 21-2. The line 25 is passed over a pulley connected to a fixed position on the vessel V. The method includes the step of pulling or releasing the line 25 with respect to the pulley (not shown in FIG. 4A) to elevate or lower the awning extension 41 in accordance with the extent to which the line 25 is pulled over the pulley.

In the method, in accordance with FIG. 4B, of lowering an awning 41′ from an elevated position, the steps include attaching a frame 40′ to the awning 41′, connecting a line to the frame 40′, and passing the line over a pulley 42′ connected to a position, such as the side of a building, in fixed relationship to the awning 41′. The method includes the step of pulling or releasing the line over the pulley 42′ to elevate or lower an object in accordance with the extent to which the line is pulled over the pulley.

Having fully described our invention it is to be understood that we do not wish to be limited to the details herein set forth or to the details illustrated in the drawings, but our invention is of the full scope of the appended claims.

1. Apparatus for moving an object comprising:
a frame formed by opposed side members joined to an end member; and
movable means having a position for applying force connected to said frame and having a single end extending to said position for applying force;
whereby a force applied to the end of said movable means can exert a force on said frame to move it to a final position.

2 Apparatus as defined in claim 1 wherein said object comprises a boat attachable to said frame mounted above a deck of a vessel.

3. Apparatus as defined in claim 1 for providing a protective cover, wherein said frame is covered by an awning.

4. Apparatus as defined in claim 2, wherein said boat is attachable to side members of said frame at ends opposite their joinder to said end member.

5. Apparatus as defined in claim 2, wherein a first line has one end connected at the intersection of said frame with one of said side members; a second line has one end connected at the intersection of said frame with the other of said side members; and said first line and said second line are joined to said movable means, comprising a pulley is mounted on an overhead member

6. Apparatus as defined in claim 3, wherein said first line extends continuously to said second line and forms a triangle therewith.

7. Apparatus as defined in claim 6, wherein said movable means is attached to a mid-position of the continuous extension of said first line to said second line.

8. Apparatus as defined in claim 7, wherein the connection of said means to said continuous extension causes said first line and said second line to form a triangular configuration with respect to said end member and an awning is confined to said frame.

9. Apparatus as defined in claim 8, wherein said continuous extension is a cord.

10. The method of moving an object comprising the steps of:
(a) forming a frame by opposed side members joined to an end member;
(b) connecting one end of a first line to the intersection of said frame with one of said side members;
(c) connecting one end of a second line to the intersection of said frame with the other of said side members;
(d) connecting the other ends of said first line and said second line by means having a single end for applying force to maintain said frame in a horizontal position; and
(e) lowering said frame from said horizontal position to make contact with an object to be elevated.

11. The method as defined in claim 10 comprising the step of elevating said object as a boat attachable to said frame.

12. The method as defined in claim 10 comprising the step of providing a protective cover over said frame by an awning forming a web between members of said frame.

13 The method as defined in claim 11 comprising the step of attaching said boat to said frame.

14. The method of moving an object from one position to another position, comprising the steps of:
(a) attaching a frame to said object;
(b) connecting a line to said frame;
(c) passing said line to a position in fixed relationship to said object; and
(d) lowering said frame from a horizontal position into contact with said object.

15. The method of claim 14 for elevating a boat from a water level to an elevated position comprising the steps of:
(a) attaching to said boat a frame pivotally connected above said boat;
(b) connecting a line to said frame; and
(c) passing said line over a pulley connected to a position in fixed relationship to said boat.

16. The method of claim 14 for lowering an awning from an elevated position comprising the steps of:
(a) attaching a frame to said awning;
(b) connecting a line to said frame; and
(c) passing said line over a pulley connected to a position in fixed relationship to said awning.

17. The method as defined in claim 15, further including the step of pulling said line over said pulley to elevate said boat in accordance with the extent to which said line is pulled over said pulley.

18. The method as defined in claim 16, further including the step of releasing said line over said pulley to lower said awning in accordance with the extent to which said line is released over said pulley.

19. The method as defined in claim 17, further including the step of pulling said line over said pulley to cause said line to form a triangular configuration with respect to said end member.

20. The method as defined in claim 18, further including the step of forming a triangular configuration at an end of said line when said awning is elevated or lowered.
